(19) United States
(12) Patent Application Publication
(10) Pub. No.: US 2017/0098483 A1
(43) Pub. Date: Apr. 6, 2017

(54) HEAT EXCHANGE SYSTEM AND NUCLEAR REACTOR SYSTEM

(71) Applicant: Institute of Modern Physics, Chinese Academy of Sciences, Lanzhou, Gansu (CN)

(72) Inventors: Wenlong Zhan, Lanzhou, Gansu (CN); Lei Yang, Lanzhou, Gansu (CN)

(73) Assignee: Institute of Modern Physics, Chinese Academy of Science, Lanzhou, Gansu (CN)

(21) Appl. No.: 15/128,007

(22) PCT Filed: Jun. 3, 2015
(86) PCT No.: PCT/CN2015/080653

§ 371 Date: Sep. 21, 2016

(30) Foreign Application Priority Data
Feb. 13, 2015 (CN) 201510081166.5

(51) Int. Cl. G21C 15/14; G21C 15/16; G21C 1/08; F22B 37/26

(52) U.S. Cl. CPC G21C 15/14; F22B 37/268; G21C 15/16; G21C 1/084

(57) ABSTRACT

The present invention discloses a heat exchange system and a nuclear reactor system. The heat exchange system includes: a heating device; a heat consuming device connected with the heating device through a pipe to form a loop; and a steam, which is in a wet steam state before being supplied to a heat source, and is supplied to the heat consuming device after becoming dry steam or superheated steam by exchanging heat with the heating device. Heat exchange efficiency and security of the nuclear reactor system are improved by adopting steam as a heat exchange medium.

### BACKGROUND

1. Technical Field

The present invention relates to a heat exchange system and a nuclear reactor system.

2. Description of the Related Art

Generally, liquid metal is adopted as a cooling medium for a reactor system.

### SUMMARY

The object of the present invention is to provide a heat exchange system and a nuclear reactor system, thereby improving heat exchange efficiency and security of the nuclear reactor system by adopting steam as a heat exchange medium.

According to embodiments of the present invention, there is provided a heat exchange system comprising: a heating device; a heat consuming device connected with the heating device through a pipe to form a loop, and a steam, which is in a wet steam state before being supplied to a heat source, and is supplied to the heat consuming device after becoming dry steam or superheated steam by exchanging heat with the heating device.

According to embodiments of the present invention, the heat exchange system further comprises: a steam-water separator disposed downstream of a steam outlet of the heating device in the loop and configured to separate liquid water from steam outputted from the heating device.

According to embodiments of the present invention, the heat exchange system further comprises: a humidity control device disposed upstream of a steam inlet of the heating device in the loop and configured to control a humidity of the steam.

According to embodiments of the present invention, the heat exchange system further comprises: a temperature control device disposed upstream of the humidity control device in the loop and configured to control a temperature of the steam.

According to embodiments of the present invention, the heat exchange system further comprises: a pressure control device disposed upstream of the temperature control device in the loop and configured to control a pressure of the steam.

According to embodiments of the present invention, the heat consuming device is a heat exchanger or a power generation system.

According to embodiments of the present invention, the steam is formed of heavy water.

According to embodiments of the present invention, a steam inlet of the heating device is disposed on a lower side of the heating device, the steam outlet of the heating device is disposed on an upper side of the heating device, and the steam-water separator is disposed above the steam outlet of the heating device.

According to embodiments of the present invention, there is provided a nuclear reactor system comprising: a nuclear reactor; a heat consuming device connected with the nuclear reactor through a pipe to forma loop; and a steam, which is in a wet steam state before being supplied to the nuclear reactor, and is supplied to the heat consuming device after becoming dry steam or superheated steam by exchanging heat with the nuclear reactor.

According to embodiments of the present invention, the nuclear reactor system further comprises: a steam-water separator disposed downstream of a steam outlet of the nuclear reactor in the loop and configured to separate liquid water from steam outputted from the nuclear reactor.

In the embodiments of the present invention, the steam as a cooling medium has advantages that it has a large thermal capacity, can be used with a low-pressure system, is non-corrosive, can be processed off-line, and the like. A fission reactor cooled by the steam as a cooling medium can be operated safely and reliably at a high power density.

### BRIEF DESCRIPTION OF THE DRAWINGS

FIG. 1 is a schematic diagram of a nuclear energy system according to an embodiment of the present invention;

FIG. 2 is a schematic diagram of a nuclear reactor system according to a first embodiment of the present invention;

FIG. 3 is a schematic diagram of a nuclear reactor system according to a second embodiment of the present invention;

FIG. 4 is a schematic diagram of a reactor according to an embodiment of the present invention; and

FIG. 5 is a schematic diagram of a fuel circulation for generating energy according to an embodiment of the present invention.

### DETAILED DESCRIPTION OF THE EMBODIMENTS

A further description of the invention will be made as below with reference to embodiments of the present invention taken in conjunction with the accompanying drawings.

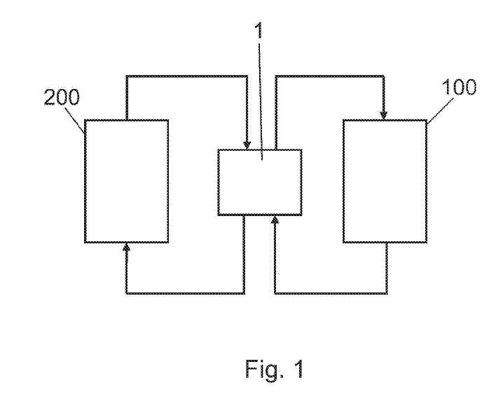

FIG. 1 shows a schematic diagram of a nuclear enemy system according to an embodiment of the present invention. As shown in FIG. 1, a nuclear energy system according to an exemplary embodiment of the present invention comprises: a nuclear reactor system 100 and a fuel circulation system 200. The nuclear energy system may be a fast neutron nuclear energy system. The nuclear reactor system 100 may be a fast neutron nuclear reactor system.

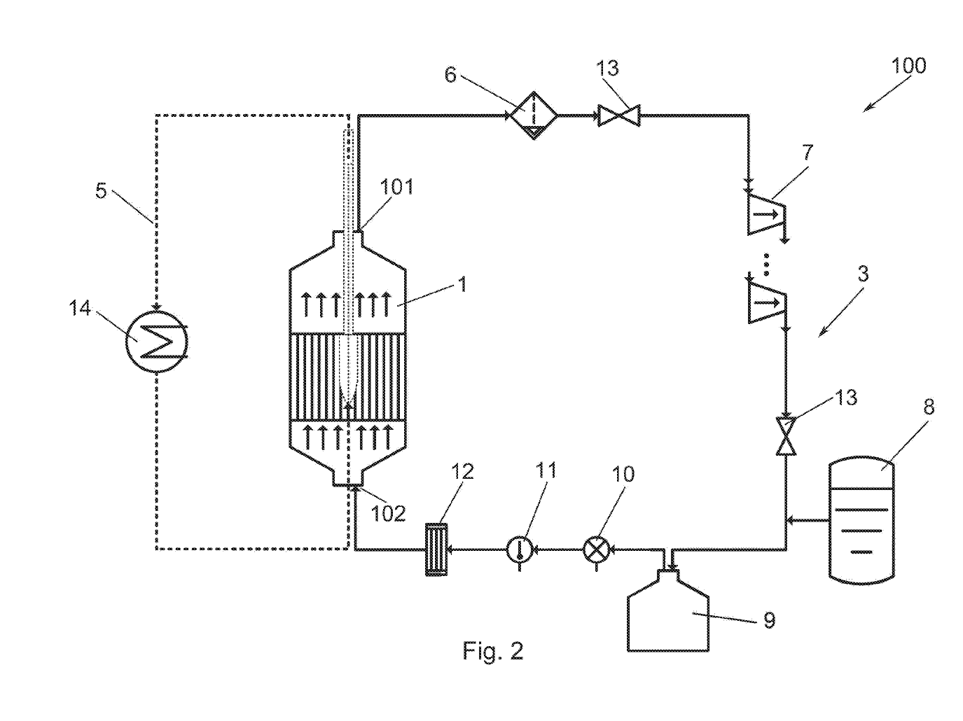

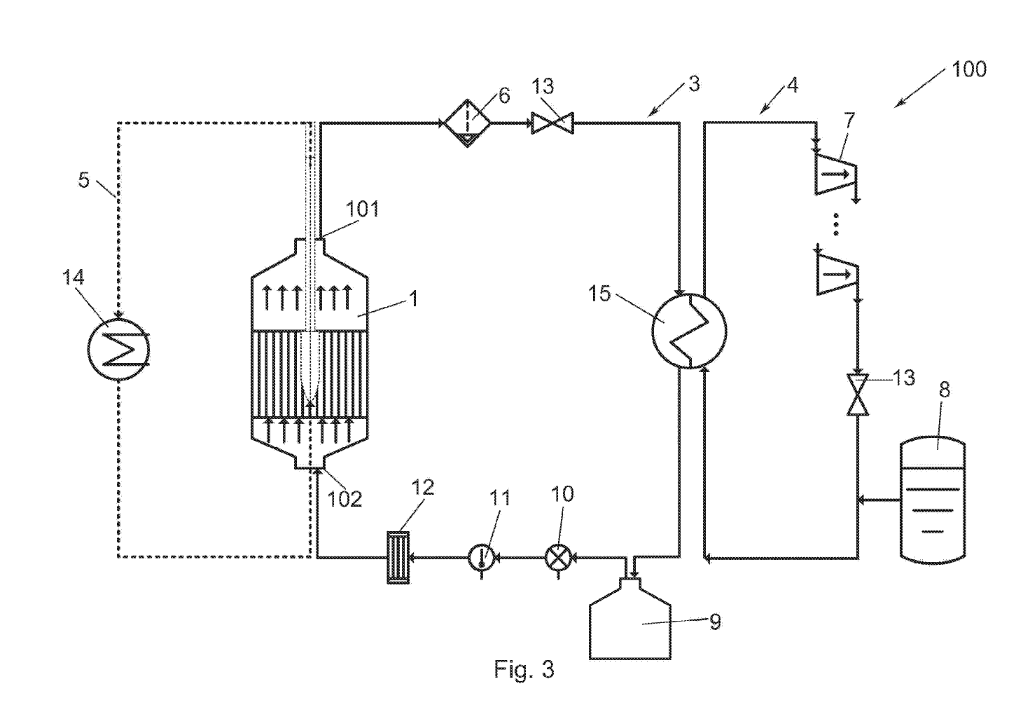

FIG. 2 shows a schematic diagram of a nuclear reactor system according to a first embodiment of the present invention, and FIG. 3 shows a schematic diagram of a nuclear reactor system according to a second embodiment of the present invention.

As shown in FIGS. 2 and 3, the nuclear reactor system 100 according to the embodiment of the present invention comprises: a nuclear reactor 1 (an example of a heating device); a heal consuming device connected with the nuclear reactor 1 through a pipe to form a loop 3; and a steam, which is in a wet steam state before being supplied to the nuclear reactor 1, and is supplied to the heat consuming device after becoming dry steam or superheated steam by exchanging heat with the nuclear reactor 1. The heat consuming device may be a power generation system 7 shown in FIG. 2, or a heat exchanger 15, such as a steam generator, shown in FIG. 3. The steam may be formed of heavy water.

As shown in FIGS. 2 and 3, the nuclear reactor system 100 may further comprise: a steam-water separator 6 disposed downstream of a steam outlet 101 of the nuclear reactor 1 in the loop 3 and configured to separate liquid water, for example water drops, from steam outputted from the nuclear reactor 1.

As shown in FIGS. 2 and 3, the nuclear reactor system 100 may further comprise: a humidity control device 12 disposed upstream of a steam inlet 102 of the nuclear reactor 1 in the loop 3 and configured to control a humidity of the steam.

As shown in FIGS. 2 and 3, the nuclear reactor system 100 may further comprise: a temperature control device 11 disposed upstream of the humidity control device 12 in the loop 3 and configured to control a temperature of the steam.

As shown in FIGS. 2 and 3, the nuclear reactor system 100 may further comprise: a pressure control device 10 disposed upstream of the temperature control device 11 in the loop 3 and configured to control a pressure of the steam.

As shown in FIGS. 2 and 3, the steam inlet 102 of the nuclear reactor 1 is disposed on a lower side of the nuclear reactor 1, the steam outlet 101 of the nuclear reactor 1 is disposed on an upper side of the nuclear reactor 1, and the steam-water separator 6 may be disposed above the steam outlet 101 of the nuclear reactor.

As shown in FIGS. 2 and 3, a heat exchange system of the nuclear reactor system 100 may convert heat into electric energy in two manners. A first manner is a direct power generation manner in which steam in the loop 3 directly propels a steam turbine to generate power, as shown in FIG. 2, and a second manner is an indirect power generation manner in which firstly heat exchange is performed between the loop 3 and a loop 4 and then steam in the loop 4 propels a steam turbine to generate power, as shown in FIG. 3.

In the embodiment shown in FIG. 2, the nuclear reactor system 100 comprises: a steam-water separator 6, a steam turbine 7 for generating power, a steam supply system 8, a radioactive pollutant processing system 9, a pressure control device 10, a humidity control device 11, a temperature control device 12, a control valve 13 and a high-temperature and high-pressure resistant pipe. The steam-water separator 6 may be located above the steam outlet 101 of the nuclear reactor 1 so as to separate the steam from liquid drops, thereby preventing the liquid drops from entering the steam turbine 7 to damage its blades. A boiling-water reactor steam-water separator may be selected to serve as the steam-water separator 6. However, the nuclear reactor system 100 may not comprise the steam-water separator 6 since the nuclear reactor system can produce steam having a very high dryness. A plurality of steam turbines 7 may be disposed downstream of the steam-water separator 6 as required to forma steam turbine set. The steam turbine set may drive a generator set to generate power. A medium-pressure steam turbine set and a low-pressure steam turbine set, which is currently commonly used in a reactor system, may be used as the steam turbine set. The steam supply system 8 is mainly used to supplement steam in the loop to ensure normal operation of the loop. The radioactive pollutant processing system 9 functions to process pollutant such as radioactive steam with impurities. The pressure control device 10 functions to control a steam pressure at the steam inlet 102 of the reactor 1. A high-pressure boiler may be used as the pressure control device 10 to control the pressure. The temperature control device 11 is mainly used to adjust a steam temperature at the steam inlet 102 of the reactor 1. A tube bundle heating structure may be used inside the temperature control device 11. The humidity control device 12 functions to adjust a steam humidity at the steam inlet 102 of the reactor 1. A spray type control method may be used to adjust the steam humidity. The control valve 13 functions to control a flow rate of the stream according to the pressure and the temperature of the steam. An induction type high-temperature and high-pressure control valve may be used as the control valve 13.

As shown in FIG. 2, a direct heat exchange system is manly composed of the reactor 1 and the loop 3. The direct heat exchange system is configured to mainly function to transmit heat from the reactor to the wet steam by heat exchange, so that the wet steam becomes the dry steam or the superheated steam. The steam which has been heated enters the power generation system in the loop 3 to directly propel the steam turbine 7 to generate power. Cooled steam generated after generating power may firstly enter the radioactive pollutant processing system 9 to dispose of neutron poisoning fission product. The steam of which the fission product has been disposed of may enter the pressure control device 10, the temperature control device 11, and the humidity control device 12 in sequence so that the pressure and the temperature of the steam are adjusted and the humidity of the steam is adjusted and controlled. Wet steam which meets standards after its parameters have been readjusted enters the reactor 1 from the steam inlet 102 of the reactor 1, and enters a passage of a reactor core inside the reactor 1 through the high-temperature and high-pressure resistant pipe, so as to transfer heat inside the reactor 1 to the wet steam by means of heat exchange. The wet steam is converted into dry steam or superheated steam by temperature rise and phase transition. The dry steam or superheated steam is discharged from atop of the reactor 1, and enters the loop 3 again, if it is detected that there is not enough steam in the heat exchange system, the steam supply system 8 may be invoked to supplement steam in the loop to ensure normal operation of the loop. According to embodiments of the present invention, the wet steam in the loop 3 may have a humidity of 1%-100%, a working pressure of 1 MPa-12 MPa, and a working temperature of 250° C.-950° C. Steam formed of light water may be used as a heat exchange medium in the loop 3.

In the embodiment shown in FIG. 3, the heat exchange system or the nuclear reactor system 100 mainly comprises: a reactor 1, a loop 3 and a loop 4. Specifically, the heat exchange system or the nuclear reactor system 100 comprises a steam-water to separator 6, a steam turbine 7 for generating power, a steam supply system 8, a radioactive pollutant processing system 9, a pressure control device 10, a temperature control device 11, a humidity control device 12, a control valve 13, a steam generator 15 for heat exchange between the loop 3 and the loop 4, a high-temperature and high-pressure resistant pipe and the like. The steam generator 15 is a device for heat transmission between the loop 3 and the loop 4. The steam generator 15 heats steam in the loop 4, by means of dry steam or superheated steam of heavy water in the loop 3, so that the steam in the loop 4 becomes high-temperature steam. The high-temperature steam propels the steam turbine 7 to generate power in the loop 4. Steam cooled after exchanging heat in the loop 3 firstly enters the radioactive pollutant processing system 9 to dispose of neutron poisoning fission product. The steam of which the fission product has been disposed of enters the pressure control device 10, the temperature control device 11, and the humidity control device 12 in sequence so that the pressure and the temperature of the steam are adjusted and the humidity of the steam is adjusted and controlled. Wet steam which meets standards after its parameters have been readjusted enters the reactor 1 from the steam inlet 102 located below the reactor 1, and enters a passage of a reactor core inside the reactor through the high-temperature and high-pressure resistant pipe, so as to transfer heat inside the reactor to the wet steam by means of heat exchange. The wet steam is converted into dry steam or superheated steam by temperature rise and phase transition. The dry steam or superheated steam is discharged from a top of the reactor 1, and enters the steam generator 15 again. If it is detected that there is not enough steam in the heat exchange system, the steam supply system 8 may be invoked to supplement steam in the loop 4 to ensure normal operation of the loop 4. A power generation system 7 is mainly composed of medium-pressure steam turbines 7 and low-pressure steam turbines 7, which mainly function to generate power by means of high-temperature steams at different pressures. The steam formed of heavy water may be used as a heat exchange medium in the loop 3, and the steam formed of light water may be used as a heat exchange medium in the loop 4.

As shown in FIGS. 2 and 3, the nuclear reactor system may operate as a critical reactor system (as shown by the solid lines in FIGS. 2 and 3), or may also operate as a subcritical reactor core or a blanket driven by an external neutron source (as shown by the solid lines and the dashed lines in FIGS. 2 and 3).

During operation of the reactor as a critical reactor, wet steam as coolant of the reactor is heated to about 200° C. in the temperature control device 11, a pressure of the wet steam is adjusted to 3-12 MP in the pressure control device 10, and the wet steam enters the reactor core at a speed of 10-70 m/s. The temperature of the steam at the outlet can reach 400° C.-950° C. by exchanging heat in the reactor core. In this way of exchanging heat, it can be ensured that the reactor core can operate at a high power density.

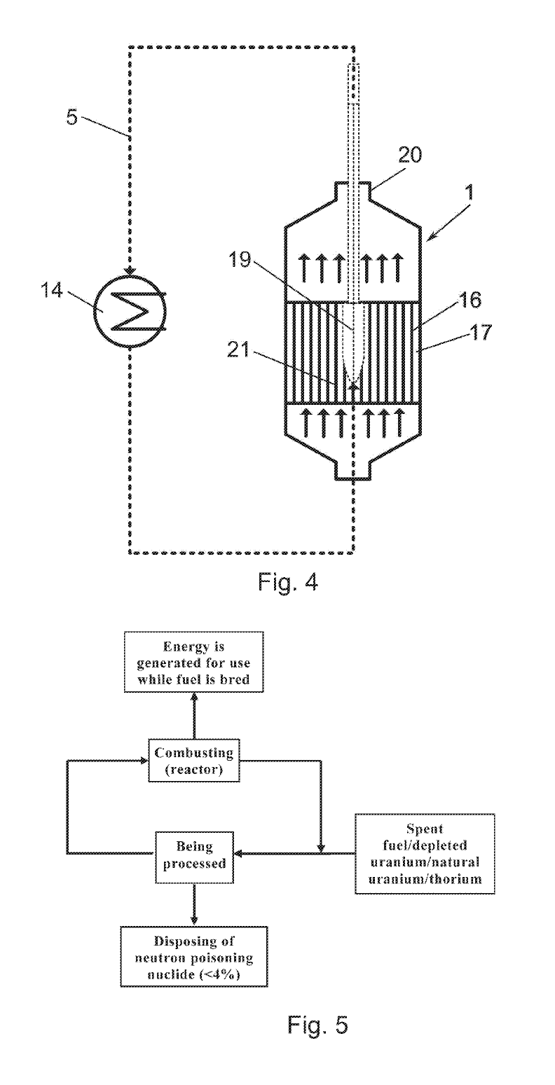

As shown in FIG. 4, during operation of the reactor system as a subcritical reactor system, a spallation target 19 for generating a driving neutron source penetrates into a reactor pressure vessel 20 and the reactor core 21, is located inside the reactor core 21, and is a sealed structure, an as to eradicate contact between spallation working substance in the spallation target and coolant in the reactor core. Heat deposition generated by coupling a beam with the spallation target 19 is exchanged through a spallation target heat exchange system 14. A loop 5 of the spallation target heat exchange system 14 is independent of the loop 3 of the nuclear reactor system 100. During operation of the critical reactor, an external source drive device is not needed. In other words, self-maintaining fission can occur in the critical reactor. The nuclear reactor 1 has a fuel rod 16. Wet steam as a reactor heat exchange medium enters a passage 17 in the reactor through the inlet 102 at a bottom of the reactor 1, and exchanges heat with the reactor so as to take away heat and thus cool the reactor.

Principles of the fuel circulation system 200 are shown in FIG. 5. The fuel circulation system comprises two parts for processing and combusting spent fuel (which is a nuclear fuel combusted in a reactor. A neutron poisoning nuclide is removed from spent fuel generated in the nuclear reactor system (or depleted uranium, natural uranium, thorium, and the like) by being processed by means of a simple high-temperature dry method. The remaining spent fuel is made into an element, and is placed into the combustor (a reactor) to combust. In the combustor, new fuel is formed by breeding fuel while a minor actinide (MA) content is reduced, and such a cycle is repeated many times. In a process of the fuel circulation system, no unwanted radioactive waste is generated and energy may be generated while nuclear waste is transmuted and bred.

During processing spent fuel by the fuel circulation system according to an embodiment of the present invention, only about 50% of fission product is removed, and an actinide element still remains in the fuel so as to continue to combust. Thereby, separation difficulty and cost are greatly decreased. In addition, a total amount of discharged nuclear waste is also greatly decreased (the total amount of the discharged nuclear waste is less than 4% of a total amount of spent fuel), and thus radioactive poisonousness is greatly decreased (an MA content is less than 0.1% of an original MA content of spent fuel).

If the wet steam is used as a cooling medium, a heat exchange pressure inside the reactor of the heat exchange system can be lower than that of a system in which pure gas is used as a cooling medium. The system in which the wet steam is used as a cooling medium has higher safety and controllability than a system in which pure water is used as a cooling medium. The fission reactor in which the heat exchange medium of the embodiments of the present invention is used is suitable for a fast neutron spectrum or a ultra-fast neutron spectrum, can satisfy the high-power density requirement, can use uranium 235, thorium, uranium 238, a long-lived fission product, and a transuranium element as a nuclear fuel, and can be used for transmutation of a spent nuclear fuel and production of an isotope.

The wet steam according to the embodiments of the present invention, which is used as a cooling medium, can provide a better heat exchange effect than a conventional single-phase medium since the wet steam itself can change in phase when being heated, and heat exchange efficiency can also be controlled by adjusting a local pressure.

A combination of a Brayton cycle and a Rankine cycle may be used for directly generating power by the nuclear reactor system.

A normal water loop, which is similar to a loop of a current pressurized water reactor may be used as the loop 4 for indirectly generating power by the nuclear reactor system as shown in FIG. 3.

The steam is a medium existing simultaneously in both a gaseous state and a liquid state in a particular space. The gaseous steam also comprises superheated steam. The steam may have a density of 1 g/m³˜80 g/m³. Material for the reactor core may be SiC composite material.

In the embodiments of the present invention, the steam as a cooling medium has advantages that it has a large thermal capacity, can be used with a low-pressure system, is non-corrosive, can be processed off-line, and the like. A fission reactor cooled by the steam as a cooling medium can be operated safely and reliably at a high power density.

In addition, the heat exchange system according to the present invention may also be used for exchanging heat between other heating device and other heat consuming device.

1. A heat exchange system comprising:
a heating device;
a heat consuming device connected with the heating device through a pipe to form a loop; and
a steam, which is in a wet steam state before being supplied to the heating device, and is supplied to the heat consuming device after becoming dry steam or superheated steam by exchanging heat with the heating device.

2. The heat exchange system of claim 1, further comprising:
a steam-water separator disposed downstream of a steam outlet of the heating device in the loop and configured to separate liquid water from steam outputted from the heating device.

3. The heat exchange system of claim 1, further comprising:
a humidity control device disposed upstream of a steam inlet of the heating device in the loop and configured to control a humidity of the steam.

4. The heat exchange system of claim 3, further comprising:
a temperature control device disposed upstream of the humidity control device in the loop and configured to control a temperature of the steam.

5. The heat exchange system of claim 4, further comprising:
a pressure control device disposed upstream of the temperature control device in the loop and configured to control a pressure of the steam.

6. The heat exchange system of claim 1, wherein:
the heat consuming device is a heat exchanger or a power generation system.

7. The heat exchange system of claim 1, wherein:
the steam is formed of heavy water.

8. The heat exchange system of claim 2, wherein:
a steam inlet of the heating device is disposed on a lower side of the heating device, the steam outlet of the heating device is disposed on an upper side of the heating device, and the steam-water separator is disposed above the steam outlet of the heating device.

9. A nuclear reactor system comprising:
a nuclear reactor;
a heat consuming device connected with the nuclear reactor through a pipe to form a loop; and
a steam, which is in a wet steam state before being supplied to the nuclear reactor, and is supplied to the heat consuming device after becoming dry steam or superheated steam by exchanging heat with the nuclear reactor.

10. The nuclear reactor system of claim 9, further comprising:
a steam-water separator disposed downstream of a steam outlet of the nuclear reactor in the loop and configured to separate liquid water from steam outputted from the nuclear reactor.
